(19) United States
(12) Patent Application Publication
(10) Pub. No.: US 2006/0153046 A1
(43) Pub. Date: Jul. 13, 2006

(54) Method and apparatus for recording marks on a write-once record carrier

(76) Inventors: Erwin Rinaldo Meinders, Eindhoven (NL); Joachim Wilhelm Hellmig, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/561,851

(22) PCT Filed: Jun. 29, 2004
(86) PCT No.: PCT/IB04/51041

§ 371 Date: Dec. 21, 2005

(30) Foreign Application Priority Data
Jul. 3, 2003 (EP) QQ101996.1

(51) Int. Cl. G11B 7/00

(52) U.S. Cl. 369/116

(57) ABSTRACT

The present invention relates to a method and a corresponding apparatus for recording marks representing data in an information layer of a write-once record carrier by irradiating the information layer by means of a radiation beam, wherein a mark is written by a write pulse (10) and said information layer comprises an organic material. In order to reduce pit deterioration which occurs when marks are written after a short space, in particular at high speed write once recording, it is proposed according to the present invention that the write pulse (10) comprises a front portion (21, 22) having a write power level increasing with time.

The present invention relates to a method and a corresponding apparatus for recording marks representing data in an information layer of a write-once record carrier by irradiating the information layer by means of a radiation beam, wherein a mark is written by a write pulse and said information layer comprises an organic material.

Thermal interference is a major problem currently faced at high-speed write-once recording. The problem is mainly encountered if a mark is followed by a short space (e.g. an 13 space, i.e. a space having a time length of 3 periods T of a reference clock). For DVD+R recording, this is better known as pit shrinkage due to post heat. The writing of the next marks effects the formation of the previous mark. At low speeds, the time in between two write pulses, which are preferably block-shaped, for writing the two marks is sufficiently long to allow the recording stack comprising the information layer to sufficiently cool down. Then, the writing of the next mark does not effect the formation of the trailing mark edge. But if the recording speeds increases, the time in between the two write pulses reduces accordingly.

This can be understood from the fact that the physical length of the mark remains the same for all recording speeds, while the dwell time reduces with increasing recording velocity. The reduced cooling time will cause a post heat effect of the previously written mark, both by direct laser heating and heat diffusion through the recording stack. As an example of this post heat problem data were written at 4×DVD+R with nominal power and with 10% overpower. It has been shown that the shortest mark (13) deteriorates if it is followed by an 13 space.

Pit shrinkage is a major problem that restricts the total data capacity and/or data transfer rate. It is not fully understood what exactly the mechanism is behind the mark deterioration (shrinkage) but it is assumed to be a sort of anneal effect that only occurs in the cooling down phase of the stack. Mark deterioration is not present if 13 marks are written at 9T distance and if in the next write cycle, when the stack has completely cooled down, 13 marks are written exactly in between the previously written 13 marks. In this way an 13-13 carrier is written in which no traces of mark deterioration was observed.

It is therefore an object of the present invention to provide a recording method and apparatus by which the above problems, in particular the problem of mark deterioration can be overcome. This object is achieved according to the present invention by a method as claimed in claim 1, according to which the write pulse comprises a front portion having a write power level increasing with time. A corresponding device comprising radiation source and a control unit is defined in claim 11.

The present invention is based on the idea to reduce thermal interference occurring during writing between two marks, in particular if the intermediate space is short, to give a postponed write boost by providing an increasing leading edge (front portion) of the write pulse, for instance a ramp-shaped or staircase-shaped leading edge. Ultimately, ultra-short write pulses of high write power at the end of a 1T block would postpone the temperature rise of the previous area considerably, but such high write powers are not available from current and near-future laser diodes. The increasing laser power at the leading edge is therefore needed to heat up the environment prior to real dye decomposition (writing). The trailing edge of the proposed write pulse preferably lacks a corresponding decrease since an as-high-as-possible quench rate is desired in order to obtain sharp mark edges.

Preferred embodiments of the invention are defined in the dependent claims. Different shapes of the front portion are defined in claims 2 to 5. According to a first preferred embodiment the front portion has a write power level that is continuously increasing with time, resulting in a ramp-shaped leading edge. Alternatively, a staircase-shaped leading edge is used as claimed in claim 3, wherein said front portion consists of n sub-portions, n being an integer number larger than 1, the i-th sub-portion having an i-th write power level, i being an integer number in the range between 1 and n, the i-th portion preceding the (i+1)-th portion, and wherein the i-th write power level is lower than the (i+1)-th write power level. Preferably said front portion consists of n portions of substantially the same duration.

Generally, a ramp-shaped leading edge is more preferred to a stair-shaped edge; however, but a staircase is the logical consequence of limited time resolution. Since the number of discrete levels is limited in optical recording devices, a compromise is typically pursued between dynamic resolution (number of power levels) and the number of time increments. In some optical recording devices, write strategy optimisation is done in the time domain, fine tuning of writing behaviour by time shifts, in other devices, fine tuning is done by fine tuning the power levels. Therefore, in some cases, the time resolution forces the definition of a staircase behaviour instead of the ramp.

A deviated profile, like an exponentially increasing power, may also be beneficial in some cases, for example at ultra-high speed recording.

Less annealing and thus less pit deterioration can be further obtained by an advantageous embodiment according to which the front portion has an end portion having an increased write power level which is higher than a normal write power level of the subsequent portions of the write pulse. Thus, an overboost is provided at the end of the front portion before the power level returns to the normal write power level applied during the rest of the write pulse.

Preferably, the write pulse comprises a time length of xT for writing an xT mark, x being an integer number larger than 1 and T representing the length of one period of a reference clock, and wherein said front portion has a time length of T and the remaining portion of the write pulse has a time length of (x−1)T. This means that the front portion exactly has a time length of during which the power level increases During the remaining time the power level is preferably kept constant at the normal write power level. According to an alternative embodiment the time length of the front portion can also be shorter or longer than one period T of the reference clock.

Further, it is preferred in a different embodiment that the whole write pulse including the front portion has a length of (N−1)T when a NT mark shall be written, i.e it is also possible to write a mark of length NT with an (N−1)T write strategy.

As already mentioned above it is preferred that write pulses comprising an increasing front portion according to the present invention, i.e. where the write power level increases with time, are only used for recording marks after short spaces, in particular after spaces having a time length of yT, y being 3 for a CD or DVD record carrier and being 2 for a BD record carrier. After such short spaces the problem of pit deterioration during writing a pit after a short space is maximum. When writing pits after longer spaces much less pit deterioration occurs. Thus, the increase of the write power level in the front portion could be made dependent on a length of the previous space. For instance, the front portion could be made IT long for a 3T pit, 0.5T long for a 4T pit, 0.25T long for a 5T pit and 0.125T long for 6T-11T pits.

Further, according to another embodiment the time length of the front portion is made dependent on recording velocity. As the recording velocity increases, the time in between two write actions reduces accordingly. For an increased velocity, the length of the front portion increases. However, not too much energy should be lost in that case, since the available laser power is required for writing at high speeds.

According to a preferred embodiment the write pulse has, except for the front portion, a block-shaped form, preferably comprising a constant power level. In alternative embodiments, the power level of the block-shaped write pulse is reduced in the block to compensate for the heating up of the recording stack. This leads to a gradually decreasing power. A further possibility is a kind of pulsed block where the power level is slightly pulsed. Still further, a dog-bone write pulse is beneficial to write the leading and trailing edge of the mark somewhat broader to improve the readout characteristics.

The recording apparatus according to the invention is arranged for carrying out a method according to the invention. To this end it comprises a radiation source for providing the radiation beam and a control unit operative for controlling the power of the radiation beam and for providing the write pulse for recording the marks. The control unit is further operative for controlling the power of the radiation beam such that said block-shaped write pulse comprises a front portion having a write power level increasing with time. The control unit may be implemented using conventional analogue or digital electronic devices, such as switching units, pattern generators and the like. Alternatively, the control unit may be implemented by a digital processing unit and an appropriate software program controlling this processing unit.

The invention will now be explained in more detail with reference to the drawings, in which

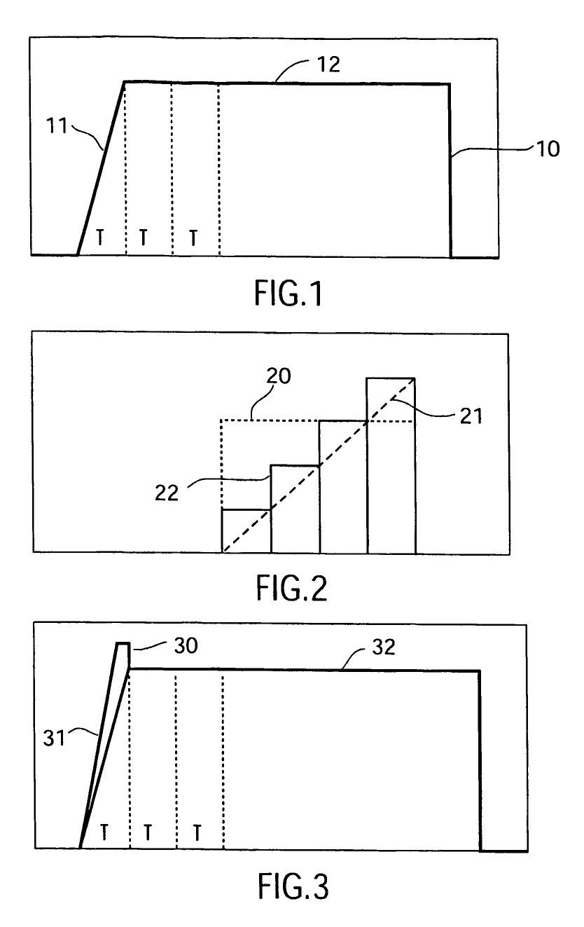

FIG. 1 shows a diagram of the time-dependency of a control signal for controlling the power of the radiation beam according to an embodiment of the invention,

FIG. 2 shows different implementations of the front portion of a write pulse in such a control signal,

FIG. 3 shows a diagram of the time-dependency of a control signal according to another embodiment,

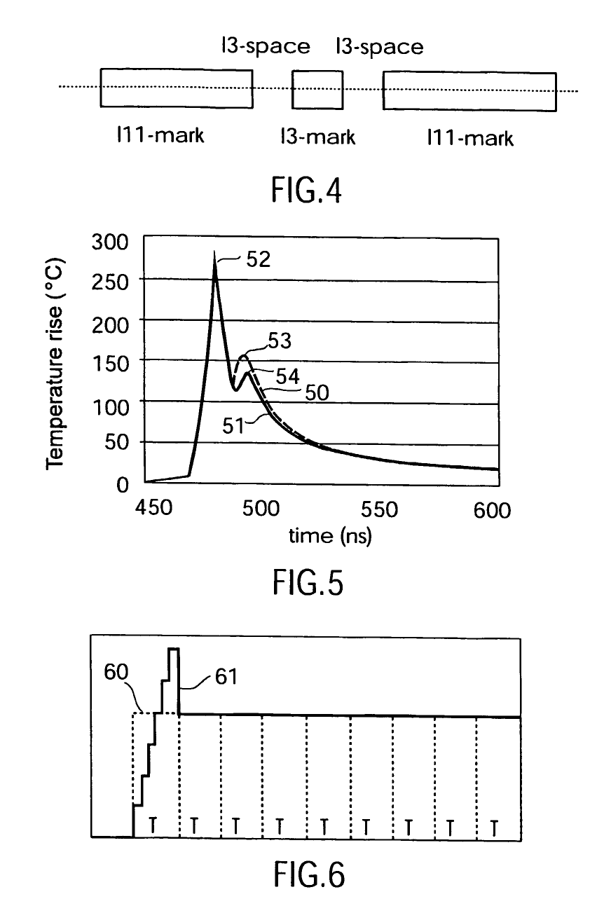

FIG. 4 illustrates the preferred area of application of the invention,

FIG. 5 shows the temperature-time profile at the trailing edge of an 13 mark in between 13 spaces preceded and followed by an I11 mark,

FIG. 6 shows a diagram of the time-dependency of a control signal according to still another embodiment,

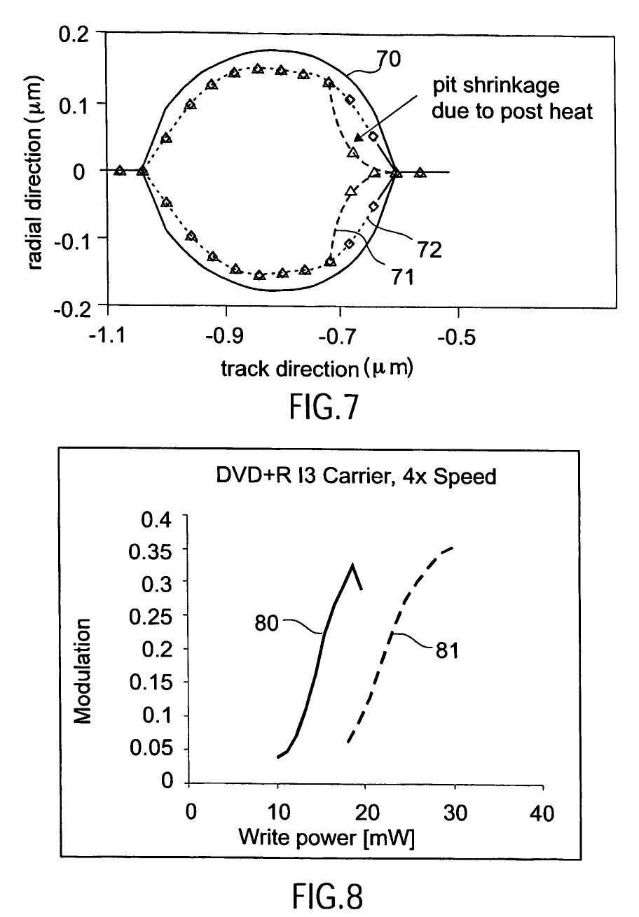

FIG. 7 shows mark formation simulations of an 13 mark,

FIG. 8 shows the modulation of an 13 mark as function of the write power for a known write strategy and a write strategy according to the present invention,

FIG. 9 shows a diagram of the time-dependency of control signals according to further embodiments and

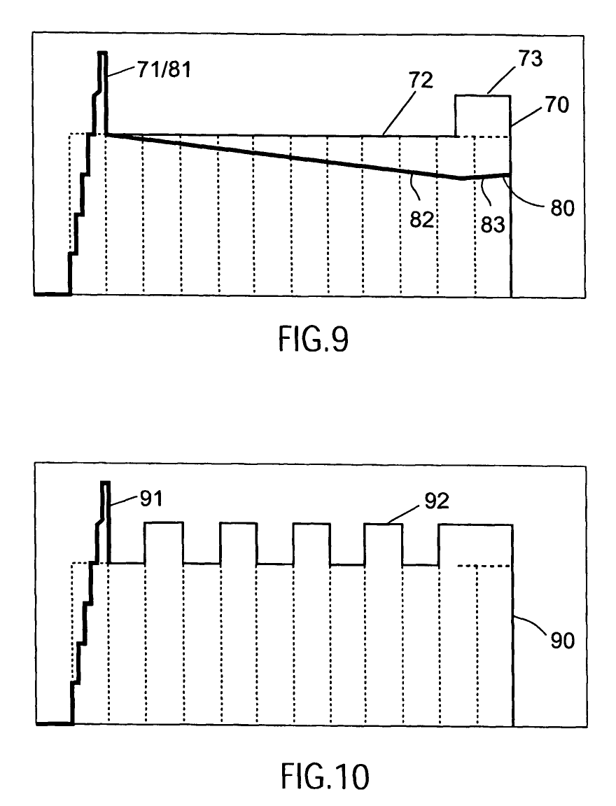

FIG. 10 shows a diagram of the time-dependency of a pulsed control signal according to still a further embodiment.

The diagram of FIG. 1 shows the time-dependency of a control signal 10 for controlling the power of the radiation beam according to a first embodiment of the invention. In this embodiment the front portion (leading edge) 11 of a write pulse is provided with a ramp edge, i.e. the write power level is continuously increasing with time until it reaches a “normal” write power level. The remaining portion 12 of the write pulse is kept constant on this normal write power level. Such a control signal 10 is, for example, used to write a 9T mark with an 8T long write pulse (including the front portion of a time-length of 1T) when applying an (x−1) write strategy which is particularly used for recording information on a write-once record carrier having an information layer made of an organic (such as, for example, a dye) material.

Different implementations of front portions are shown in FIG. 2. 20 indicates the known (standard) block shaped front portion, 21 indicates the ramp edge shown in FIG. 1 and 22 indicates a staircase-shaped front portion, which staircase has a number of steps having equal time lengths and equal step sizes in this embodiment. It should be noted that parameters like the number of steps, the step size, duration etc. depend very much on the recording stack and the recording velocity. The number of steps can generally be between 2 and N, N being at least 20, and the step size is generally between 2 and 99% of the normal write power level, preferably between 5 and 10%.

To provide an extra power boost 30, a modification of the front portion can be used such as proposed in FIG. 3. This extra power boost 30 is preferably applied at the end of the front portion 31 and before the normal power level portion 32, and has a power level larger than the normal power level applied during portion 32. This leads to an even better reduction of thermal interference at high speed recording.

The invention is preferably applied in situations shown in FIG. 4 where an 13 mark has to be written in between two long Ill marks, separated by 13 spaces. The temperature-time responses at the trailing edge 40 of the 13 mark are compared for a blocked (50) and a staircase (51) write strategy in FIG. 5. The staircase consisted of 6 time steps in which the power was varied in increments of 25% of the write power, thus 25%, 50%, 75%, 100%, 125% and 150%. The control signal 61 including such a staircase-shaped front portion is shown in the diagram of FIG. 6 showing also a control signal having a known block-shaped front portion 60. The first temperature rise 52 at the trailing edge 40 is caused by the write pulse to actually write the mark, the second temperature rise 53 is due to post heat from the following II I mark. Post heat includes both the temperature rise by direct heating of the laser beam, but also heat diffusion through the recording stack. It can be seen that the second temperature rise 53 is suppressed, or at least much lower (peak 54), in case a staircase shaped leading edge is used when the 13 mark is followed by an 13 space. It is noted that the first write pulse, to actually write the first I11 mark, hardly causes a temperature rise at the trailing edge of the 13 mark.

Further, pit shrinkage has been modeled as a sort of anneal process. The pit shapes that results from the numerical simulations are shown in FIG. 7. The pit shape 71 that results from a block shaped write pulse (all three pits are written with a blocked pulse) is characterized by severe pit shrinkage compared to the initial pit shape 70. It is obvious that the reduced temperature rise in case of the staircase pulse (the second I11 pit is written with the staircase pulse as shown in FIG. 6) leads to less annealing and thus too less pit deterioration as can be seen from the pit shape 72.

Experimental evidence of the benefits of a staircase write strategy is given in FIG. 8. Shown is the modulation of an 13 mark as a function of write power (for a DVD+R 13 carrier, 4×speed). While the modulation 80 saturates and eventually drops at too high write powers for the blocked strategy, the achieved modulation 81 is much higher and seems not too drop for the staircase pulse shape where the power was varied in increments of 25% of the write power, thus 25%, 50%, 75% and 100%.

FIGS. 9 and 10 show further embodiments of control signals according to the present invention compared to a known block-shaped control signal having a constant power level as indicated by the dashed line. Shown is in FIG. 9 a control signal 70 having a staircase shaped front portion 71 having an overboost, a dog-bone pulsed middle portion 72 having an almost constant power level and an increased end portion 73. Such a control signal 70 is beneficial to write the leading and trailing edge of a mark somewhat broader in order to improve the read-out characteristics.

Another possible control signal is indicated by reference sign 80 having also a staircase shaped front portion 81, a gradually decreasing middle portion 82 and a constant end portion 83. The gradually decreasing power level in the middle portion 82 is used to compensate for the heating up of the recording stack.

A third control signal 90 is shown in FIG. 10 having a staircase-shaped front portion 91 and a slightly pulsed remaining portion 92 wherein the power level is pulsed between two levels around or above the normal power level of the known block-shaped pulse.

1. A method of recording marks representing data in an information layer of a write-once record carrier by irradiating the information layer by means of a radiation beam, wherein a mark is written by a write pulse (10) and said information layer comprises an organic material,
characterized in that said write pulse (10) comprises a front portion (21, 22) having a write power level increasing with time.

2. Method as claimed in claim 1,
wherein said front portion (11, 21, 31) has a write power level which is continuously increasing with time.

3. Method as claimed in claim 1,
wherein said front portion (22) consists of n sub-portions, n being an integer number larger than 1, the i-th sub-portion having an i-th write power level, i being an integer number in the range between 1 and n, the i-th portion preceding the (i+1)-th portion, and wherein the i-th write power level is lower than the (i+1)-th write power level.

4. Method as claimed in claim 3,
wherein said front portion (22) consists of n portions of substantially the same duration.

5. Method as claimed in claim 1,
wherein said front portion (31) has an end portion (31) having an increased write power level which is higher than a normal write power level of the subsequent portions (32) of the write pulse.

6. Method as claimed in claim 1,
wherein said write pulse (10) comprises a time length of xT for writing a xT mark, x being an integer number larger than 1 and T representing the length of one period of a reference clock, and wherein said front portion has a time length of T and the remaining portion of the write pulse has a time length of (x−1)T.

7. Method as claimed in claim 1,
wherein the front portion of the write pulse has a time length smaller or larger than 1T, T representing the length of one period of a reference clock.

8. Method as claimed in claim 1,
wherein write pulses (10) comprising a front portion (21, 22) having a write power level increasing with time are only used for recording marks after short spaces, in particular after spaces having a time length of yT, y being 3 for a CD or DVD record carrier and being 2 for a BD record carrier.

9. Method as claimed in claim 1,
wherein write pulses (10) comprising a front portion (21, 22) having a time length which is dependent on the recording velocity, in particular which is increasing with an increasing recording velocity.

10. Method as claimed in claim 1,
wherein said write pulse has, except for the front portion, a block-shaped form having a substantially constant, gradually decreasing or slightly pulsed power level.

11. A recording device for recording marks representing data in an information layer of a write-once record carrier by irradiating the information layer by means of a radiation beam, wherein a mark is written by a write pulse and wherein said information layer comprises an organic material, the device comprising a radiation source for providing the radiation beam and a control unit operative for controlling the power of the radiation beam and for providing the write pulse (10) for recording the marks,
characterized in that the control unit is operative for controlling the power of the radiation beam such that said write pulse (10) comprises a front portion (21, 22) having a write power level increasing with time.
